(19) United States
(12) Patent Application Publication
(10) Pub. No.: US 2008/0010514 A1
(43) Pub. Date: Jan. 10, 2008

(54) Backup power supply and desktop computer and method for protecting the data thereof

(76) Inventor: Ta-Wei Liu, Taipei City (TW)

Correspondence Address: J. C. Patents, Inc., Suite 250, 4 Venture, Irvine, CA, 92618, US

(21) Appl. No.: 11/475,271

(22) Filed: Jun. 26, 2006

(30) Foreign Application Priority Data
Jun. 19, 2006 (TW) 95121867

(51) Int. Cl. G06F 11/00

(52) U.S. Cl. 714/14

(57) ABSTRACT

A backup power supply, a desktop computer and the method for protecting the data thereof are described. The method comprises the steps of judging whether the desktop computer is in the suspend-to-memory mode, judging whether the system power of the desktop computer fails and then providing a backup power to the memory of the desktop computer when the desktop computer is in the suspend-to-memory mode and the system power of the desktop computer fails.

### CROSS-REFERENCE TO RELATED APPLICATION

This application claims the priority benefit of Taiwan application serial no. 95121867, filed on Jun. 19, 2006. All disclosure of the Taiwan application is incorporated herein by reference.

### BACKGROUND OF THE INVENTION

1. Field of the Invention

The present invention is related to a method of protecting data of computer, and more particularly. to a method of protecting data of desktop computer.

2. Description of the Related Art

With advancement of science and technology, computers are the necessary equipment for people in their daily life. Presently, a conventional personal computer generally includes a central processing unit (CPU), a chipset, a memory, storage devices, interface connecting devices and power supply. Therein, the CPU is the heart of the whole computer which handles the operation thereof; the chipset is to handle communication and control between the CPU and other components inside of the computer; the memory is used for storing programs and data during computer operation, and a memory is usually adopted by a dynamic random access memory (DRAM) which has large capacity and low price; the storage devices are with large capacity that are used for storing data in a long period such as the hard disk or the optical disk drive and so forth; the interface connecting devices are with function to enable a user to connect other peripherals of the computer for operation, such as to connect keyboard, mouse or printer interface and so forth. As for the power supply, it serves to transfer external power to power of different voltages such as _{—}5V, −5V, +12V or −12V and so forth that the internal circuit of the computer is in demand.

In the initial development of personal computer, power was controlled by hardware, which means the necessary operation power was provided by the power supply to the computer system. And the power supply was connected to an external power via a switch, which would be turned on while a user wanted to use the computer. The power supply is connected to an external power to provide operation power to the computer system for its subsequent operation after being switched on. When a user does not want to use the computer and is ready to switch off the power, the power supply cuts off the external power and stops supplying power to the computer system. A computer can not boot automatically in such easy way that switch-on and switch-off are controlled by a switch.

However, with advancement of science and technology, software and hardware that easy to use and learn are getting more important. The personal computer industries have also defined many new specifications to follow the trend. Therein, to provide better integration and more functions to personal computers, the industries have defined personal computers with ATX (Advanced Technology Expanding) standard so that the power supply is not the only device to control switch on and switch off by a switch, but the switch on and switch off of the computer can be controlled by the control circuit inside the computer system. The power supply provides necessary operation power to the computer system by main power and to power control units by backup power. The power supply keeps providing backup power as long as it connects to external power. Therefore, the power supply stops providing main power to the computer system but provides backup power to the power control units when the computer is switched off. Afterwards, Intel, Microsoft and Toshiba submitted ACPI (Advanced Configuration and power interface) standard that defines four standby states of the computer system within operation and switch off. The computer decides to enter one of the four states according to operation loading so as to save power. Therein, by saving power from least to most the states can be roughly ranked as follows: S1 and S2 are “power on suspend”, S3 is “suspend to memory”, i.e. memory sleep mode, S4 is “suspend to disk” and S5 is “soft off”. During the state of suspend to memory, except real-time clock of motherboard, other clock pulses have stopped. At this time, CPU and other circuits have stopped operations due to no power. Considering S3 (suspend to memory) state, its advantage is to stop most operations in order to lower power exhausted from the system when the computer has entered to this state.

Because current household electric appliances are in the trend of computerization, therefore, if the personal computer with S3 state can be quickly back to operation from sleep mode and operate right away without waiting for long boot time, the computer can function instantly such as the household electric appliance. However, during the time period from S3 state to normal operation of the system, the data that store in the memory temporarily may be lost if the power supply or external power fails at this period that makes the power supply to the memory of the motherboard stopped. As a result, the desktop computer can not be back to the original condition before the state of suspend to memory when operating in normal mode.

To sum up, it is obvious that the disadvantages of prior arts include: when the computer enters to the state of suspend to memory as defined in ACPI standard, though current system data in operation are stored in the memory and the main power is switched off except the backup power so as to provide power to the memory and relevant circuits to save power, and conveniently restore back to the original operation condition. However, all the data stored in the memory may lose if abnormal power supplies happened during the state of suspend to memory that resulted in huge damage to users.

### SUMMARY OF THE INVENTION

The primary purpose of the present invention is to provide a desktop computer including a motherboard, a power supply and a backup power that will supply power to the memory of the motherboard when the desktop computer is in the state of suspend of memory and the power supplied by the power supply was cut off so that data stored in the memory will not lose even abnormal power failure happened during the mode of suspend of memory.

Another purpose of the present invention is to provide a backup power supply used for desktop computer that is capable of providing power to the memory of the motherboard when the computer is in the state of suspend of memory and the power supplied by the power supply was cut off so that data stored in the memory will not lose even abnormal power failure happened during the mode of suspend of memory.

Another purpose of the present invention is to provide a method of protecting data of the desktop computer. The method is to provide backup power to the memory of the desktop computer when the desktop computer is in the state of suspend to memory and the system power was cut off, so as to prevent abnormal power failure during the state of suspend to memory that resulted in the loss of the data stored in the memory so as to achieve the purpose of protecting the data of the desktop computer.

According to the above and other purposes, the present invention provides a desktop computer which includes a motherboard, a power supply and a backup supply that provide power to the memory of the motherboard when the desktop computer is in the state of suspend to memory and the power supplied by the power supply was cut off.

The desktop computer described according to preferred embodiments of the present invention, the above backup power supply includes a battery module and a control circuit. The control circuit enables the battery module to provide power to the memory when the desktop computer is in the state of suspend to memory and the power supplied by the power supply was cut off.

From another view, the present invention provides a backup power supply used for desktop computer. The backup power supply includes a battery module and a control circuit. The control circuit enables the battery module to provide power to the memory when the desktop computer is in the state of suspend to memory and the power supplied by the power supply was cut off.

The backup power supply described according to the present invention, the above desktop computer includes a detection circuit to provide state signals to inform the backup power supply whether the desktop computer is in the state of suspend to memory.

From another view, the present invention provides a method of protecting the data of the desktop computer, which includes judging whether the desktop computer is in the state of suspend to memory, judging whether the system power of the desktop computer is cut off and providing backup power to the memory of the desktop computer when the desktop computer is in the state of the suspend to memory and the system power is cut off.

The method of protecting the data of the desktop computer described according to preferred embodiments of the present invention, the above backup power is provided by batteries and the method of protecting the data of the desktop computer further includes using the system power to charge the batteries.

The present invention provides a method to prevent the desktop computer in the state of suspend to memory affected by abnormal power failure. The method includes using backup power to charge the memory of the desktop computer continuously when the system power was cut off so as to prevent data stored in the memory from being lost and the desktop computer can be back to the original system condition before the state of suspend to memory when operating in normal mode.

In order to make the aforementioned and other objectives, features and advantages of the present invention comprehensible, preferred embodiments accompanied with figures are described in detail below.

### PREFERRED EMBODIMENTS OF THE INVENTION

FIG. 1 is a diagram showing part of devices of the desktop computer according to the present invention. Please refer to FIG. 1, the desktop computer in the present embodiment includes a motherboard 100, a power supply 150 and a backup power supply 160. Therein, the motherboard 100 includes a CPU 110, a memory 120, a detection circuit 130, a connector 140, a power socket 142 and a first step-down regulator 144. The detection circuit 130 includes a south bridge chip 132. And the backup power supply 160 includes a battery module 162, a battery 136, a control circuit 164, a second step-down regulator 166 and a capacitor 168. The CPU handles the operations of the whole computer, the chipset handles the communication and control of the CPU with other components inside of the computer, the memory uses for storing programs and data during computer operation and generally adopts DRAM with large capacity in low price. During the operation of the desktop computer, the power supply 150 transfer external power to power of different voltages that the internal circuit of the computer is in demand. The power supply 150 supplies power to the motherboard 100 by connecting the power socket 142 and the motherboard 100. Besides, the power socket 142 also connects to the connector 140. The power supply 150 of the present embodiment takes power supply of ATX structure as an example, and the power supply will keep providing a 5V standby power (5VSB) to the memory 120 via the connector 140 as long as connecting to a power source. And the memory standard can be decided optionally by adopting such as SDRAM (Synchronous Dynamic Random Access Memory), DDR SDRAM (Double Data Rate Synchronous Dynamic Random Access Memory) or DDRII DRAM (Double Data Rate II Dynamic Random Access Memory) and so on. The operation voltages of these different memories are also quite different. For example, the operation voltage of SDRAM is 3.3 volt, the operation voltage of DDR SDRAM is 2.5 volt, and the operation voltage of DDRII DRAM is 1.8 volt. Therefore, the 5VSB provided by the power supply to the connector 140 needs the first step-down regulator 144 to lower the operation voltage suitable for the different memory.

When the supplied power from the power supply 150 is normal, the supplied power is provided by the power supply 150 to the memory 120 via the connector 140, and the power supply 150 also provides a voltage (for example, 12 volt) to charge the battery 163 of the backup power supply 160 via the charge line 170 so as to be used as the power source of the backup power supply 160. Once the operation of the desktop computer enters to the S3 state from normal operation state, the data of system condition of the desktop computer will be stored in the memory 120 before entering to the S3 state. In another aspect, the south bridge chip 132 of the detection circuit 130 will immediately send a state signal TI to inform the backup power supply 160 that the desktop computer is entering to the S3 state and the supplied power is still provided by the power supply 150 to the memory 120 during S3 state. However, if supplied power from the power supply 150 during S3 state is abnormal, the backup power supply 160 can judge whether the supplied power from the power supply 150 is cut off by the signal provided from the connector 140 or the power supply 150. For example, the voltage itself provided by the power supply 150 or the connector 140 could be the base of judging whether the supplied power from the power supply 150 is cut off. When it is determined that the supplied power from the power supply 150 is cut off, the control circuit 164 of the power supply 160 will switch to enable the battery module 162 to keep charging the memory 120 via the connector 140 to ensure that the data of the system condition stored in the memory 120 before the desktop computer entering to the S3 state will not lose.

However, during the period from the supplied power from the power supply in the S3 state is cut off and the control circuit 164 switches to enable the backup power supply 160 to keep charging the memory 120, a switch period is occurred. The memory 120 still keeps being charged in this period. Therefore, the capacitor 168 of the backup power supply 160 keeps supplying power to the memory 120 in this period to ensure the data stored in the memory 120 will not lose. Moreover, the battery 163 used by the battery module 162 of the backup power supply 160 can be dry battery, lead-acid battery, Ni—Cd battery, Ni—H battery, lithium ion battery, lithium polymer battery or fuel battery and so on. For example, two lithium batteries of 3.7 volt can provide total voltage of 7.4 volt and four dry batteries of 1.5 volt can provide total voltage of 6 volt. Because the supplied voltage of the battery module 162 must be identical to the receiving voltage of the connector 140, the supplied voltage of the battery module 162 will lower to 5 volt via the second step-down regulator 166 before providing power to the connector 140. In this way, even the power supplied by the power supply 150 is cut off when the desktop computer is in the S3 state, the backup power supply 160 can still keep supplying power to the memory 120 so that the desktop computer can be back to the original operation condition by using data of the system condition stored in the memory 120 before S3 state.

FIG. 2 is a flow chart showing the method of protecting the data of the desktop computer according to a preferred embodiment of the present invention. First of all, for example, the power supply supplies power to the system and charges the battery of the backup power (step S210) as a power source of the backup power. Then, whether the desktop computer is in the S3 state is judged (step S220) by the south bridge chip of the desktop computer. Then, enter step S230 if the desktop computer is in the S3 state after being judged, i.e. to judge whether the system power of the desktop computer is cut off. The backup power will provide to the memory of the desktop computer if the system power of the desktop computer is judged being cut off (step S240).

As described above, the present invention is to provide a desktop computer that is prevented from the abnormal power failure. When the desktop computer is in the S3 state, relevant data of system condition will be stored in the memory and the backup power supply will keep supplying power to the memory of the motherboard once the power supply can not normally supply power so that the data stored in the memory will not lose even abnormal power failure happened; therefore, the desktop computer is still able to be back to the original operation condition without any data loss.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

### BRIEF DESCRIPTION OF THE DRAWINGS

FIG. 1 is a diagram showing part of devices of the desktop computer according to the present invention.

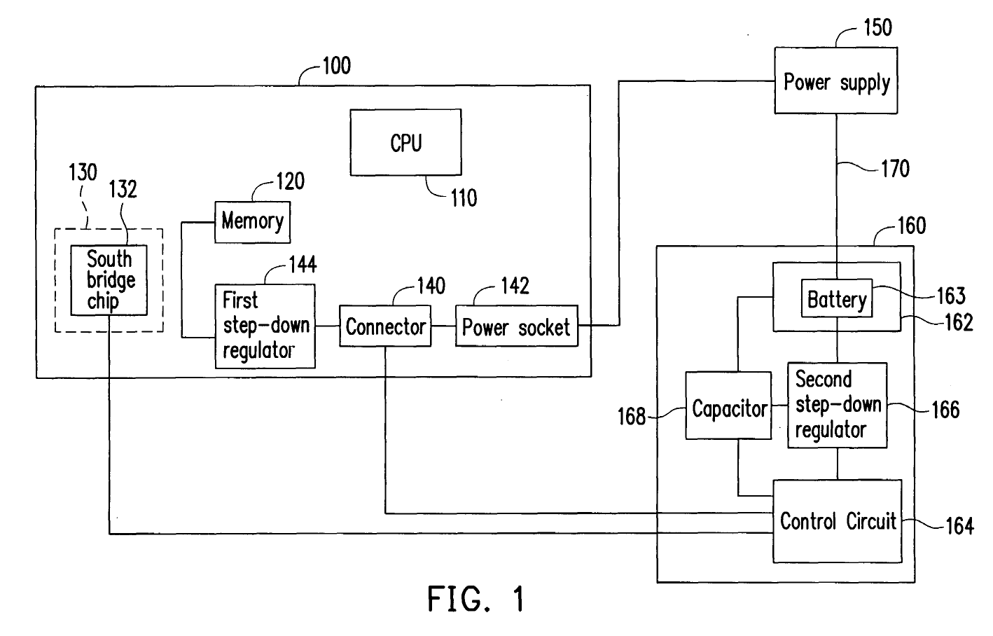

FIG. 2 is a flow chart showing the method of protecting the data of the desktop computer according to a preferred embodiment of the present invention.

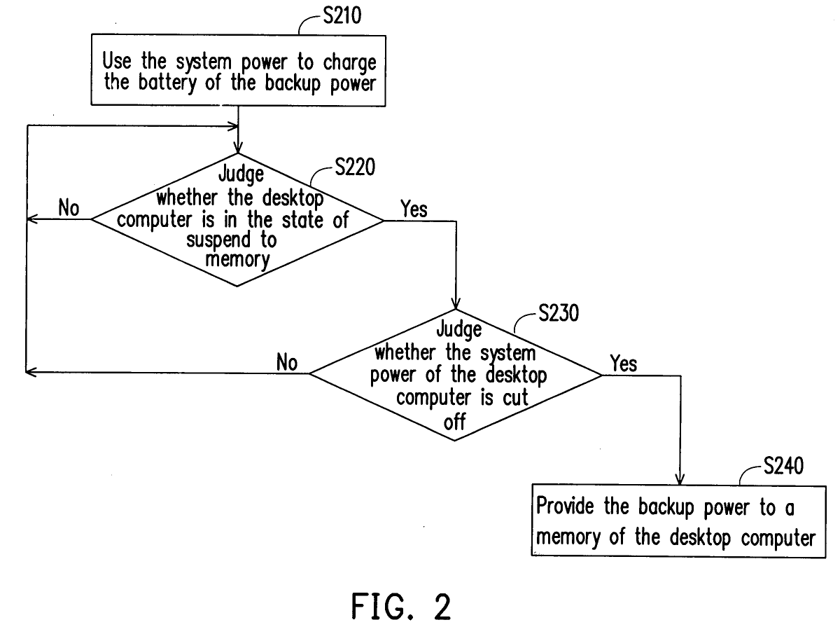

What is claimed is:

1. A desktop computer, including:
a motherboard, including a memory,
a power supply, used for supplying power to said motherboard, and
a backup power supply, used for supplying power to said memory of said motherboard when said desktop computer is in a state of suspend to memory and when the power supplied by said power supply is cut off, wherein said memory stores data of system condition of said desktop computer before said desktop computer enters to said state of suspend to memory.

2. The desktop computer according to claim 1, wherein said backup power supply includes:
a battery module, used for holding a battery to supply power to said memory, and
a control circuit, used for switching to enable said battery module to supply power to said memory when said desktop computer is in the state of suspend to memory and when the power supplied by said power supply is cut off.

3. The desktop computer according to claim 2, wherein said backup power supply further includes a step-down regulator, coupled between said battery module and said control circuit, used for lowering voltage supplied by said battery module to voltage supplied by said backup power supply.

4. The desktop computer according to claim 2, wherein said backup power supply further includes a capacitor used for supplying power to said memory during a period after the power supplied by said power supply is cut off and before the supply power by said backup power supply is started.

5. The desktop computer according to claim 2 further includes a charge line coupled between said power supply and said backup power supply so that said power supply charges said battery via said charge line.

6. The desktop computer according to claim 1, wherein said motherboard includes:
a detection circuit, used for providing a state signal to inform said backup power supply whether said desktop computer is in said state of suspend to memory.

7. The desktop computer according to claim 6, wherein said detection circuit includes a south bridge chip used for providing said state signal.

8. The desktop computer according to claim 1, wherein said motherboard includes:
a connector coupled to said power supply, said backup power supply and said memory, said power supply and said backup power supply supply power to said memory via said connector.

9. The desktop computer according to claim 8, wherein said backup power supply judges whether the power supplied by said power supply is cut off by signal provided by said connector or said power supply.

10. A backup power supply used for a desktop computer, said backup power supply includes:
a battery module, used for holding a battery to supply power to a memory of said desktop computer, and
a control circuit, used for switching to enable said battery module to supply power to said memory when said desktop computer is in a state of suspend to memory and when the system power of said desktop computer is cut off, wherein said memory stores data of system condition of said desktop computer before said desktop computer enters to said state of suspend to memory.

11. The backup power supply according to claim 10, further including a step-down regulator coupled between said battery module and said control circuit to lower voltage supplied by said battery module to voltage supplied by said backup power supply.

12. The backup power supply according to claim 10, further including a capacitor used for supplying power to said memory during a period after the system power of said desktop computer is cut off and before the supply power by said backup power supply is started.

13. The backup power supply according to claim 10, further including a charge line, said system power charges said battery via said charge line.

14. The backup power supply according to claim 10, wherein said desktop computer includes a detection circuit used for providing a state signal to inform said backup power supply whether said desktop computer is in said state of suspend to memory.

15. The backup power supply according to claim 14, wherein said detection circuit includes a south bridge chip used for providing said state signal.

16. The backup power supply according to claim 10, wherein said desktop computer includes a connector coupled to said system power, said backup power supply and said memory, said system power and said backup power supply supply power to said memory via said connector.

17. The backup power supply according to claim 16, wherein said backup power supply judges whether the system power of said desktop computer is cut off by signal provided by said connector or said system power.

18. A method of protecting data of a desktop computer, including:
judging whether said desktop computer is in a state of suspend to memory,
judging whether the system power of said desktop computer is cut off, and
providing a backup power to a memory of said desktop computer when said desktop computer is in said state of suspend to memory and when said system power is cut off,
wherein said memory stores data of system condition of said desktop computer before said desktop computer enters to said state of suspend to memory.

19. The method according to claim 18, wherein said backup power is from a battery and said method of protecting data of desktop computer further includes:
using said system power to charge said battery.

20. The method according to claim 18, wherein said desktop computer includes a south bridge chip and said method of protecting data of desktop computer further includes:
judging whether said desktop computer is in said state of suspend to memory by a signal provided by said south bridge chip.
